(19) United States
(12) Patent Application Publication
(10) Pub. No.: US 2025/0067226 A1
(43) Pub. Date: Feb. 27, 2025

(54) INTERNAL COMBUSTION ENGINE SYSTEM

(71) Applicant: VOLVO TRUCK CORPORATION, GÖTEBORG (SE)

(72) Inventors: Fredrik Larsson, VELLINGE (SE); Fredrik Rahm, HÖRBY (SE)

(21) Appl. No.: 18/779,311

(22) Filed: Jul. 22, 2024

(30) Foreign Application Priority Data
Aug. 22, 2023 (EP) 23192648.6

(51) Int. Cl. F02D 41/00; F02B 75/02; F02B 75/18; F02D 41/32; F02M 26/04

(52) U.S. Cl. CPC F02D 41/0007; F02B 75/02; F02B 75/18; F02D 41/32; F02M 26/04; F02B 2075/025; F02B 2075/1808

(57) ABSTRACT

A spark-ignition internal combustion engine, ICE, system for a vehicle, comprising a two-stroke ICE, a first cylinder accommodating a reciprocating first piston operable between a bottom dead center and a top dead center, and further at least partly defining a first combustion chamber with a top end of the first piston, at least one intake port arranged at a top end of the first cylinder and in fluid communication with the combustion chamber, and further an exhaust port arranged distal from the top end of the first cylinder, a second cylinder accommodating a reciprocating second piston operable between a bottom dead center and a top dead center, and further at least partly defining a second combustion chamber with a top end of the second piston, at least one corresponding intake port arranged at a top end of the second cylinder and in fluid communication with the second combustion chamber.

### CROSS REFERENCE TO RELATED APPLICATION

This application claims foreign priority to European Application 23192648.6 filed on Aug. 22, 2023, the disclosure and content of which is incorporated by reference herein in its entirety.

### TECHNICAL FIELD

The disclosure relates generally to an internal combustion engine system and a method for operating an internal combustion engine system. The disclosure can be applied to heavy-duty vehicles, such as trucks, buses, and construction equipment, among other vehicle types. Although the disclosure may be described with respect to a truck, the disclosure is not restricted to any particular vehicle. The internal combustion engine system may e.g. be applicable for other types of vehicles propelled by means of an internal combustion engine such as cars and other light-weight and light-duty vehicles etc. Further, the internal combustion engine of the internal combustion engine system may typically be an internal combustion engine operable on a hydrogen-based fuel.

### BACKGROUND

To reduce negative climate effects there is an increasing interest in reducing the use of fossil fuels. By way of example, reduction of exhaust gases, increasing engine efficiency, i.e. reduced fuel consumption, and lower noise level from the engines are some of the criteria that have become more important aspects when designing and selecting a suitable internal combustion engine (ICE) system and its engine component. Furthermore, in the field of heavy-duty vehicles, such as trucks, there are a number of prevailing environmental regulations that set specific requirements on the vehicles, e.g. restrictions relating to maximum allowable amount of exhaust gas pollution.

One possibility is to use hydrogen gas, produced in a fossil-free way, as fuel in internal combustion engines instead of using e.g. fossil-based diesel. The huge amount of conventional, already existing, diesel engines cannot operate properly if simply just fed with hydrogen instead of diesel; these engines must be adapted before being capable of using hydrogen fuel. However, to make such adaptation of existing diesel engines economically feasible, it is necessary that the adaptations are not too complex and costly.

### SUMMARY

According to a first aspect of the disclosure, there is provided a spark-ignition internal combustion engine, ICE, system for a vehicle. The ICE system comprises a two-stroke ICE operable on a gaseous fuel or a liquid fuel. The ICE has at least a pair of first and second cylinders with corresponding first and second cylinder walls. The first cylinder accommodates a reciprocating first piston operable between a bottom dead center and a top dead center, and further at least partly defining a first combustion chamber with a top end of the first piston, wherein the first cylinder further comprises an ignition source arranged in the first combustion chamber, at least one intake port arranged at a top end of the first cylinder and in fluid communication with the combustion chamber, wherein the flow of combustible gas through the at least one intake port is controllable by an intake control valve, and further an exhaust port arranged distal from the top end of the first cylinder, such that the at least one intake port and the exhaust port are located at different positions and separated by the piston top end when the first piston is in its top dead center, the second cylinder accommodates a reciprocating second piston operable between a bottom dead center and a top dead center, and further at least partly defining a second combustion chamber with a top end of the second piston, wherein the second cylinder further comprises a corresponding ignition source arranged in the second combustion chamber, at least one corresponding intake port arranged at a top end of the second cylinder and in fluid communication with the second combustion chamber, wherein the flow of combustible gas through the at least one corresponding intake port is controllable by a corresponding intake control valve, and further a corresponding exhaust port arranged distal from the top end of the second cylinder, such that the at least one corresponding intake port and the corresponding exhaust port are located at different positions and separated by the piston top end when the second piston is in its top dead center, the pair of first and second cylinders being arranged separated from each other with a crank angle of 180 degrees, and an air intake duct comprising a positive displacement device configured to receive and feed intake air to the at least one pair of cylinders, the positive displacement device further being arranged in the air intake duct to separate an upstream intake tract from a downstream plenum of the air intake duct, and configured to permit the downstream plenum to be in fluid communication with each one of the first and second cylinders of the at least one pair of cylinders.

The first aspect of the disclosure may seek to provide an improved two-stroke ICE system controllable to prevent transfer of pressure pulses into the induction system so as to avoid, or at least reduce backfiring. A technical benefit may include an increased versatility in the control of the combustion chamber temperature. Moreover, the proposed ICE system allows for reducing time to ignition with decreased risk of having backfiring into the induction system of the ICE system.

By the arrangement of the positive displacement device in the air intake duct, the displacement device is arranged to eliminate, or at least reduce, the risk of having pressure pulses transferred backwards from the combustion chambers to the upstream intake tract of the air intake duct.

As such, the intake ports are mechanically isolated from the intake tract. The positive displacement device is thus arranged to seal the cylinders and the downstream intake plenum from the upstream intake tract of the air intake duct (intake manifold) in case of backfire.

Also, by the arrangement and configuration of the displacement device in the air intake duct, the displacement device can still provide an even flow by the alternating feed to the cylinder pair.

Moreover, the proposed ICE system provides for suppressing the tendency for knock and/or self-ignition of the fuel, such as a gaseous fuel, e.g. hydrogen-based fuel.

By the provision of arranging the respective intake port and exhaust port of the cylinders at different positions, the corresponding piston will provide for a blocking effect between the intake and exhaust ports when the piston is in its top dead center, so that the hot part of the cylinder (exhaust port and cylinder wall/liner) will be entirely separated from the combustible gas (generally corresponding to an air/fuel mixture).

As such, the proposed ICE system enables a length-scavenging system that separates the hot exhaust end of the cylinder from the cold intake end where the combustibles are present. Therefore, the knock risk may be drastically reduced with the proposed ICE system.

By the provision of having the pair of first and second cylinders arranged separated from each other with a crank angle of 180 degrees, the two cylinders can provide a 180 degrees cycle separation irrespectively of the ICE and cylinder arrangement/configuration.

To sum up, the proposed ICE system thus provides separate intake plenum for each pair of cylinders with a 180 degrees combustion phasing separation, where the intake duct has a close coupled positive displacement device for each pair of cylinders. It should be noted that the proposed ICE system may not be restricted to a system with one single pair of cylinders, but can also be implemented in four cylinders, six cylinders etc. Hence, the proposed ICE system may have a minimum of two cylinders, but multiples of two cylinders may be possible.

Accordingly, there is provided an ICE system having forced induction in the top of the cylinders, an ignition source for igniting the fuel, while being configured to expel the exhaust gases through exhaust ports in the lower to mid parts of the cylinder, e.g. lower parts of the cylinder walls/liners.

In addition, the proposed two-stroke ICE, favorably operable on hydrogen, or any other gaseous fuel, provides for increasing the BMEP potential due to twice the firing frequency. In particular, the two-stroke cycle enable the ICE to operate at a higher lambda with a maintained power density, as compared to four stroke ICEs.

A “two-stroke operation” or “two-stroke mode” refers to a cycle of the internal combustion engine, in which the piston moves two strokes (up and down movements) between the TDC and the BDC during only one crank shaft revolution so as to complete a full work cycle. In general, the operation of the internal combustion engine when operated in a general two-stroke operation corresponds to a repetitive engine operation every crank shaft revolution.

In some examples, including in at least one preferred example, optionally the pair of first and second cylinders may be arranged separated from each other with a crank angle of 180 degrees, so as to provide a 180 degrees combustion phasing separation.

In some examples, including in at least one preferred example, optionally the fuel may be a gaseous fuel. One example of a gaseous fuel is a hydrogen-based fuel.

In some examples, including in at least one preferred example, optionally the fuel is a liquid fuel. One example of a liquid fuel is an NH3-based fuel.

In some examples, including in at least one preferred example, optionally the ignition source may be any one of a spark plug and a glow plug.

In some examples, including in at least one preferred example, optionally each one of the intake control valve and the corresponding intake control valve may be arranged to open and close a fluid passage of the respective intake port, thus controlling the flow of fluid to the respective combustion chamber.

In some examples, including in at least one preferred example, optionally the ICE system may comprise a fuel injector arrangement arranged in the downstream plenum of the air intake duct so as to provide a fuel injection upstream the intake ports of the first and second cylinders. A technical benefit may include an improved injection of fuel into the combustion chamber(s) of the ICE. Hereby, the ICE system is configured to provide port injection of the gaseous fuel or the liquid fuel.

The use of a port injection allows for providing a homogenous mixture which enables an improved knock and auto-ignition control and also contributes to reduce the emissions.

Alternatively, the fuel injector arrangement may be arranged in each one of the combustion chambers of the first and second cylinders, respectively.

In some examples, including in at least one preferred example, optionally the fuel injector arrangement may be controllable to inject fuel to the intake port and the corresponding intake port such that pressure pulses are generated in the downstream plenum and subsequently travel into the corresponding combustion chambers. A technical benefit may include an improved scavenging effect. As such, the ICE system is configured to provide a scavenging effect by the injection timing in the intake port(s). The fuel injector arrangement may generally be operable in response to a predetermined fuel injection event.

In some examples, including in at least one preferred example, optionally the fuel injector arrangement may be controllable to provide a sequential injection of fuel to the first and second cylinders so as to allow for an active cylinder scavenging during a latter part of a corresponding intake stroke of a corresponding cylinder of the first and second cylinders. Put it differently, a sequential injection may enable active cylinder scavenging (emptying of exhaust) during latter part of the intake stroke, thus creating a final pressure pulse (from the injected fuel) that increases the trapped mass in the cylinder after any exhaust port and intake valve closures. Further, the generated pressure pulse may increase the scavenging effect.

In some examples, including in at least one preferred example, optionally the intake control valve of the first cylinder may be controllable in correlation with the movement of the first piston and the intake control valve of the second cylinder may be controllable in correlation with the movement of the second piston such that fluid communication between the respective combustion chambers and the plenum being selectively open and closed during a crank shaft revolution of the ICE. A technical benefit may include to further reduce the risk of backfire.

In some examples, including in at least one preferred example, optionally the plenum may comprise an air inlet in fluid communication with the positive displacement device and a plurality of outlets configured to be in fluid communication with the intake ports of the first and second cylinders. A technical benefit may include an improved air supply system for supplying air to the cylinders. By way of example, the plenum is a Siamese-shaped design.

In some examples, each one of the cylinder heads of the first and second cylinders may have a plurality of intake control valves. The number of intake control valves for each cylinder can generally be any practical number and may generally be selected based on cylinder type and ICE type. By way of example, each one of the cylinder heads may have a number of four intake control valves. A technical benefit may include an even more improved air supply system for supplying air to the cylinders. A configuration with an ICE system having four intake control valves for each cylinder may be particularly beneficial for two-stroke operated ICE systems that may typically have a shorter intake period that four stroke ICE system. A configuration with an ICE system having four intake control valves for each cylinder allows for increasing the air intake rate into the combustion chamber of the cylinder. In addition, it may improve the scavenging phase expelling (pushing out) the exhaust in a uniform, pressure-wave, manner.

In some examples, including in at least one preferred example, optionally the intake control valves may be configured to provide variable valve actuation. A technical benefit may include an improved control of the air supply system for supplying air to the cylinders during operation of the ICE system. Variable valve actuation may also allow for tuning the phasing (valve timing) for a more optimum pulse capture and efficiency in synchronization with the fuel injection and the corresponding pulse in the plenum.

In some examples, including in at least one preferred example, optionally the positive displacement device may be a variable positive displacement device configured to be operated in a variable manner. A technical benefit may include an improved control of the flow and/or pressure of air to the cylinders during operation of the ICE system. Moreover, a variable driven positive displacement device allows for a higher flexibility of the air intake system of the ICE system and also an improved function of the ICE system on a general level.

In some examples, including in at least one preferred example, optionally the pair of first and second cylinders are arranged as a pair of neighboring cylinders. In this manner, the volumetric efficiency of the ICE system may further be improved.

In some examples, including in at least one preferred example, optionally the ICE system may further comprise additional pairs of cylinders with corresponding air intakes duct and positive displacement devices.

In some examples, including in at least one preferred example, optionally the exhaust ports may be arranged in fluid communication with an exhaust duct arranged to transport exhaust gas away from the cylinders.

In some examples, including in at least one preferred example, optionally the ICE system may further comprise a turbocharger arrangement having a turbocharger turbine operatively connected to a turbocharger compressor, wherein the turbocharger compressor is arranged in an air intake conduit to the air intake duct, and wherein the turbocharger turbine is arranged in the exhaust duct so as to drive the turbocharger compressor.

In some examples, including in at least one preferred example, optionally the ICE system may further comprise an exhaust gas recirculation EGR system comprising an EGR conduit arranged to connect the exhaust duct and the air intake duct so as to permit recirculation of exhaust gas through the cylinders during operation of the ICE.

In some examples, including in at least one preferred example, optionally the EGR system may further comprise a corresponding positive displacement device.

In some examples, including in at least one preferred example, optionally the EGR conduit may connect to the air intake conduit at a position downstream the turbocharger compressor and further connects to the exhaust duct at a position upstream the turbocharger turbine.

In some examples, including in at least one preferred example, optionally the ICE system may be a hydrogen ICE system configured to operate on a gaseous fuel containing a hydrogen-based gaseous fuel. Accordingly, the proposed ICE system may be particularly useful for hydrogen ICE systems. Hydrogen-based fuel may generally have a high auto-ignition temperature; however, low ignition energy may only be needed if a spark (or glowing surface or particle) is present. The low ignition energy may, however, pose some challenges on the ICE, e.g. it may be difficult to use a cylinder head where the hot exhaust ports/valves are located in the same combustion chamber as the intake ports/valves or in the vicinity of the compressed air/fuel mixture prior to ignition. A technical benefit of the proposed ICE system for use with a hydrogen-based fuel may include a more reliable and robust hydrogen ICE system.

In some examples, including in at least one preferred example, optionally the ICE system may be configured to collectively control the positive displacement device and the intake valves so as to control flow of gas to the combustion chambers. The positive displacement device and the intake valves may be controllable by a controller, such as an electronic control unit comprising a processing circuitry. In addition, or alternatively, the positive displacement device may be controllable by a controller and the intake valves may be controllable by one or more camshafts and/or the intake valves may be controllable by one or more corresponding actuators of the intake valves.

In some examples, including in at least one preferred example, optionally the ICE system may be configured to be controllable to terminate fuel injection during an intake phase and before an intake valve closure, whereby the remaining part of the intake phase comprises emptying the plenum of fuel and subsequently introducing fresh air to the plenum by operating the positive displacement device. By way of example, the ICE system may comprise a controller configured to terminate fuel injection during an intake phase and before an intake valve closure, whereby the remaining part of the intake phase comprises emptying the plenum of fuel and subsequently introducing fresh air to the plenum by operating the positive displacement device.

In some examples, including in at least one preferred example, optionally the ICE system may comprise a multiple set of pair of cylinders having corresponding air intake ducts with corresponding positive displacement devices.

According to a second aspect of the disclosure, there is provided a vehicle comprising an internal combustion engine system according to the first aspect and/or according to any one of the examples of the first aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary embodiment of the present disclosure, comprising a side view of a vehicle, in the form of a truck, according to an example.

FIG. 2 shows an internal combustion engine system, according to an example.

FIG. 3 shows an internal combustion engine system, according to an example.

FIGS. 4A to 4D shows an example of a combustion cycle of the internal combustion engine system in FIG. 2 and/or FIG. 3.

### DETAILED DESCRIPTION

The detailed description set forth below provides information and examples of the disclosed technology with sufficient detail to enable those skilled in the art to practice the disclosure.

For an internal combustion engine system, it may be desired to control the risk of backfiring, i.e. a condition when a flame escapes from the combustion chamber of the cylinder and travels upstream into the air intake duct. It has also been observed that managing self-ignition and backfiring in a reliable manner is particularly useful for hydrogen ICE system.

The disclosure may seek to provide an improved two-stroke ICE system controllable to prevent pressure pulses into the induction system so as to avoid, or at least reduce backfiring. A technical benefit may include an increased versatility in the control of the combustion chamber temperature. Moreover, the two-stroke ICE system allows for reducing time to ignition with decreased risk of having backfiring into the induction system of the ICE system.

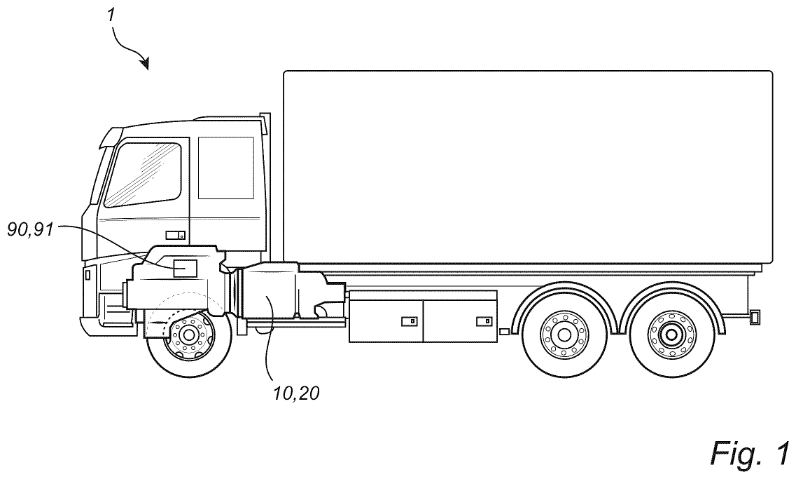

FIG. 1 is an exemplary embodiment of the present disclosure, comprising a side view of a vehicle 1, in the form of a truck, according to an example.

Whilst the shown embodiment illustrates a truck, the disclosure may relate to any vehicle, such as a car, bus, industrial vehicle, boat, ship, etc., wherein motive power may be derived from an internal combustion engine.

The vehicle 1 comprises an internal combustion engine system 10. The internal combustion engine system may generally herein refer to the ICE system 10. Moreover, the vehicle 1 may also comprise a controller 90. The controller is here part of a control system. The controller 90 may be part of the ECU of the vehicle 1. The controller 90 comprises a processing circuitry 91 configured to control the ICE system 10, as described herein.

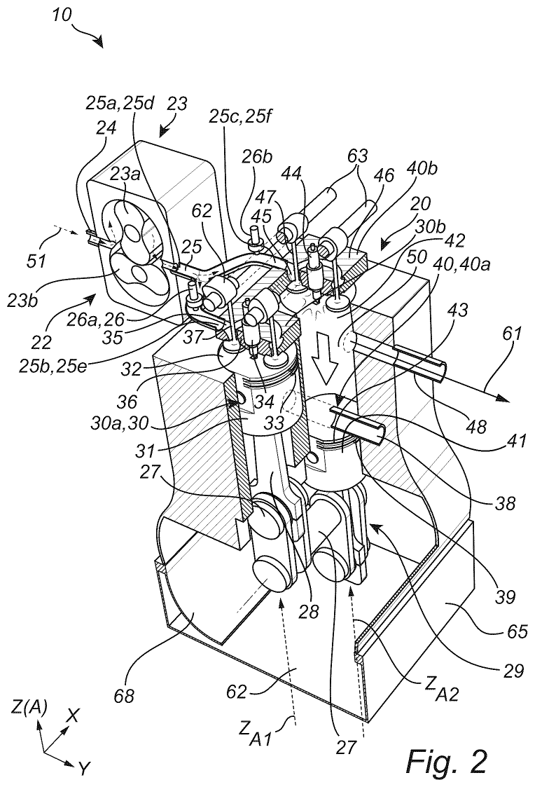

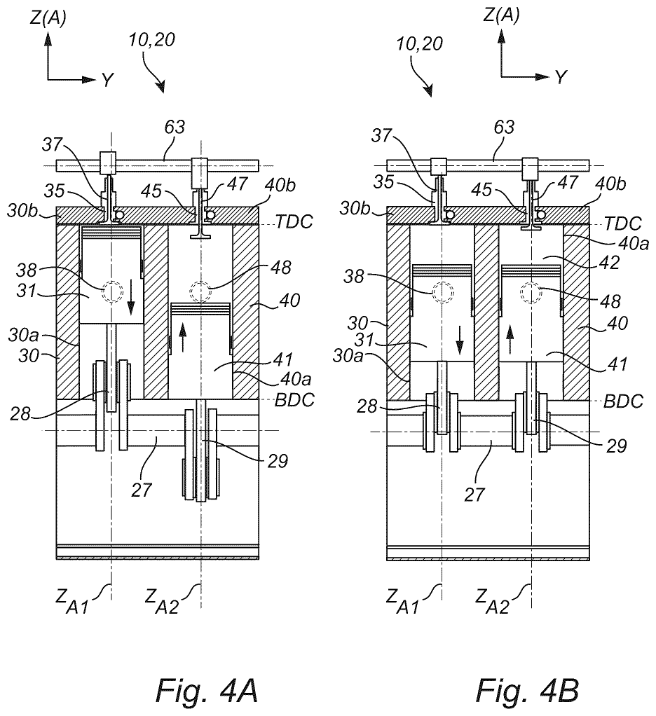

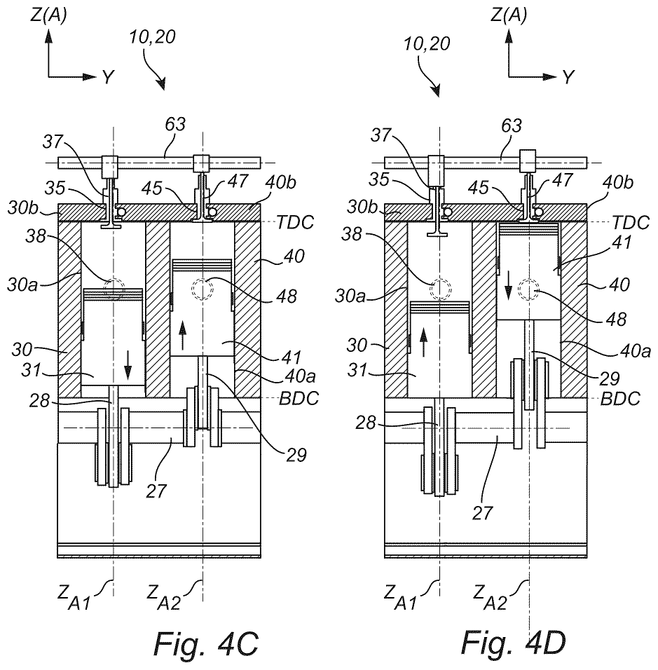

FIG. 2 shows an example of an ICE system 10. Purely by way of example, the FIG. 2 ICE system 10 may be used in the vehicle 1 of FIG. 1. The ICE system 10 will hereinafter be described in relation to FIG. 2 and FIGS. 4A to 4D.

The ICE system 10 is here a spark-ignition ICE system. The ICE system 10 comprises a two-stroke ICE 20 operable on a gaseous fuel 50 or a liquid fuel 50. One example of a gaseous fuel is a hydrogen-based fuel. One example of a liquid fuel is an NH3-based fuel. Other examples of liquid fuels are LNG, LPG, petrol, and the like.

In this example, the two-stroke ICE 20 is operable on a gaseous fuel in the form of a hydrogen-based fuel. The combustion in such hydrogen ICE system 10 is based on a combustion of air and hydrogen, as is commonly known in the art. While the combustion of hydrogen with oxygen may only produce water as its only product in a pure combustion process between hydrogen and oxygen, a hydrogen ICE system 10 based on combustion of air and hydrogen generally produce water, heat and NOx, as is commonly known in the art. In addition, hydrogen can be combusted in an internal combustion engine over a wide range of fuel-air mixtures. A hydrogen ICE system 10 may be operated to produce very low emissions during certain conditions. The hydrogen ICE system 10 may operate based on hydrogen liquid or hydrogen gas. The hydrogen ICE system 10 as described herein contributes to a leaner operation of the ICE 20, which is favorable from a NOx emission perspective.

As depicted in FIG. 2, and further in FIGS. 4A to 4D, the ICE 20 comprises a first cylinder 30 and a second cylinder 40. The first cylinder 30 comprises a first cylinder wall 30a and a first cylinder head 30b. The first cylinder wall may be part of a cylinder liner. In a similar vein, the second cylinder 40 comprises a second cylinder wall 40a and a second cylinder head 40b. The second cylinder wall may be part of a corresponding cylinder liner.

The first and second cylinders 30, 40 are here a pair of first and second cylinders 30, 40. Typically, although strictly not required, the first and second cylinders 30, 40 are here a pair of neighboring first and second cylinders 30, 40. In this context, the term “neighboring” generally means that the cylinders are arranged next to each other, i.e. adjacent to each other within the ICE system, so as to allow for forming a pair of cylinders operating according to the two-stroke operation. In other words, the first and second cylinders 30, 40 are arranged next to each other in the ICE 20. This may have a positive impact on the volumetric efficiency of the ICE system 10. However, it should be noted that the first and second cylinders may in some ICE systems be arranged slightly distanced from each other as long as the cylinders work as a pair of cylinders, i.e. the cylinders are connected to the same crank shaft and separated with a 180 crank angle degrees, as further described herein.

It should be noted that the ICE 20 may comprise any even number of cylinders. For example, the ICE 20 may comprise four, six, or eight cylinders. For ease of reference, however, the description herein is for an ICE system 10 having a pair of cylinders 30, 40.

As illustrated in FIG. 2, the ICE system 10 further comprises a crank shaft 27, a set of connecting rods, 28, 29 and a crankcase 65. The crankcase 65 is configured to accommodate the crank shaft 27 and the connecting rods 28, 29. Each one of the connecting rods 28, 29 is operatively connected to a corresponding piston, as further described below.

The ICE system 20 may also comprise an oil sump 62 and a splash plate for the oil 68. These components are conventional parts of an ICE, and not further described herein.

The first cylinder 30 is configured to accommodate a reciprocating first piston 31. The reciprocating first piston 31 is operable between a bottom dead center, BDC, and a top dead center, TDC.

More specifically, as may be gleaned from FIG. 4A in combination with FIG. 4D, the first piston 31 is arranged to reciprocate in the first cylinder 30 between the BDC (FIG. 4D) and the TDC (FIG. 4A)). With reference to FIG. 4D, the first piston 31 is in the TDC position at −360°, 0° and 360θ CAD. The first piston 31 is via a connection rod 28 connected to the crank shaft 27, which is in line with a conventional internal combustion engine.

The first piston 31 may generally comprise a suitable number of piston rings. By way of example, the first piston 31 comprises one or more compression rings and oil control rings. The number of piston rings and type of piston rings are selected based on the fuel of the ICE system 10. In this example, the piston rings are arranged at a top end 33 of the first piston 31.

The reciprocating first piston 31 further at least partly defines a first combustion chamber 32 with the top end 33 of the first piston 31. The combustion chamber 32 is arranged at the end portion, i.e. the first cylinder head 30b, of the first cylinder 30 so that an upper surface of the top end 33 defines a lower side of the first combustion chamber 32.

The first cylinder 30 further comprises an ignition source 34. The ignition source 34 is arranged in the first combustion chamber 32. The ignition source 34 is arranged in the first cylinder 30 and at a location facing the combustion chamber 32. By way of example, the ignition source 34 is arranged at an upper end of the cylinder 30, as illustrated in FIG. 2. In particular, the ignition source 34 is arranged at the cylinder head 30b of the first cylinder 30. Other arrangements of the ignition source are also conceivable.

The ignition source 34 is configured to ignite the hydrogen gas supplied via the fuel arrangement, as described herein. By way of example, the ignition source is a spark-plug 17. A spark plug is a device for delivering electric current from an ignition system to the combustion chamber of a spark-ignition engine to ignite the compressed fuel/air mixture by an electric spark, while containing combustion pressure within the engine.

In addition, the first cylinder 30 of the ICE 20 comprises at least one intake port 35 arranged at a top end 36 of the first cylinder 30 and in fluid communication with the combustion chamber 32. The top end 36 is here an integral part of the cylinder head 30b.

Moreover, the flow of combustible gas through the at least one intake port 35 is controllable by an intake control valve 37. In this example, the combustible gas may generally contain a mix of air and port injected hydrogen gas (the gaseous fuel).

The intake control valve 37 is arranged to open and close a fluid passage of the intake port 35, thus controlling the flow of fluid to the combustion chamber 32.

Further, the first cylinder 30 of the ICE 20 comprises an exhaust port 38 arranged distal from the top end 36 of the first cylinder 30, such that the at least one intake port 35 and the exhaust port 38 are located at different positions and separated by the piston top end 33 when the first piston 31 is in its top dead center.

More specifically, as illustrated in FIG. 2, the first cylinder 30 comprises a first exhaust port 38. The first exhaust port 38 is configured to exhaust combusted gas from the first cylinder 30. The first exhaust port 38 is arranged distal from the top end 33 of the first cylinder 30. Hereby, the intake port 35 and the exhaust port 38 are located at different positions and separated by the top end 33 when the first piston 31 is in its TDC. In this context, the term “distal” means that the exhaust port 38 is arranged spaced apart from the top end 33 in a direction Z of the cylinder 30 corresponding to an axial direction of the piston 31. The top end 33 is thus considered to be a proximal part of the first cylinder 30. In other words, the first piston 31 is arranged in the first cylinder 30 for reciprocal movement along a central axis ZA1, here extending in the direction Z. In other words, in this example, the axial direction of the piston 31 corresponds to the direction Z. the central axis ZA1 is thus arranged in parallel to the direction Z. Hence, the first exhaust port 38 is arranged axially distal from the top end 33 of the first cylinder 30 in the axial direction of the first cylinder 30 and the first piston 31, here corresponding to the direction Z.

By way of example, the exhaust port 38 is arranged at a lower to mid part 39 of the first cylinder 30.

In some examples, as illustrated in FIG. 2, when the first cylinder 30 comprises the first cylinder liner, the cylinder liner here also comprises the exhaust port 38 located at a lower to mid part 39 of the cylinder liner. Hence, the exhaust port 38 is generally arranged distal from the top end 33 of the first cylinder 30 and positioned in the cylinder wall 30a of the cylinder liner of the first cylinder 30.

The second cylinder 40 is configured to accommodate a reciprocating second piston 41. The reciprocating second piston 41 is operable between a bottom dead center, BDC, and a top dead center, TDC.

More specifically, as may be gleaned from FIG. 4A in combination with FIG. 4D, the second piston 41 is arranged to reciprocate in the second cylinder 40 between the BDC (FIG. 4A) and the TDC (FIG. 4D). With reference to FIG. 4A, the second piston 41 is in the TDC position at −360°, 0° and 360° C. AD. The second piston 41 is via a connection rod 29 connected to the crank shaft 27, which is in line with a conventional internal combustion engine.

The second piston 41 may generally comprise a suitable number of piston rings. By way of example, the second piston 41 comprises one or more compression rings and oil control rings. The number of piston rings and type of piston rings are selected based on the fuel of the ICE system 10. In this example, the piston rings are arranged at a top end 43 of the second piston 41.

The reciprocating second piston 41 further at least partly defines a second combustion chamber 42 with a top end 43 of the second piston 41. The combustion chamber 42 is arranged at end portion, i.e. the second cylinder head 40b, of the second cylinder 40 so that an upper surface of the top end 43 defines a lower side of the second combustion chamber 42.

Each one of the piston top ends may have a flat top or the piston top ends may be slightly dished so as to avoid hotspots.

The second cylinder 40 further comprises a corresponding ignition source 44 arranged in the second combustion chamber 42. The ignition source 44 is arranged in the second cylinder 40 and at a location facing the combustion chamber 42. By way of example, the ignition source 44 is arranged at an upper end of the combustion cylinder 40, as illustrated in FIG. 2. In particular, the ignition source 44 is arranged at the cylinder head 40b of the second cylinder 40. Other arrangements of the ignition source are also conceivable.

Each one of the ignition sources 34, 44 is here a spark plug. The ignition source may also be a glow plug.

Accordingly, in each cylinder, there is a corresponding spark plug arranged to ignite a mix of fuel and oxygen in the cylinder. The hydrogen fuel is generally compressed to a certain level. The compressed air-fuel mixture is thus ignited by the spark plug.

In addition, the second cylinder 40 of the ICE 20 comprises at least one corresponding intake port 45 arranged at a top end 46 of the second cylinder 40 and in fluid communication with the second combustion chamber 42. The top end 46 is here an integral part of the cylinder head 40b.

Moreover, the flow of combustible gas through the at least one corresponding intake port 45 is controllable by a corresponding intake control valve 47. In this example, the combustible gas may generally contain a mix of air and port injected hydrogen gas (the gaseous fuel).

The intake control valve 47 is arranged to open and close a fluid passage of the intake port 45, thus controlling the flow of fluid to the combustion chamber 42.

Further, the second cylinder 40 of the ICE 20 comprises a corresponding exhaust port 48 arranged distal from the top end 46 of the second cylinder 40, such that the at least one corresponding intake port 45 and the corresponding exhaust port 48 are located at different positions and separated by the piston top end 43 when the corresponding second piston 41 is in its top dead center.

In a similar vein to the first cylinder and its exhaust port, the corresponding exhaust port 48 is configured to exhaust combusted gas from the second cylinder 40. The corresponding exhaust port 48 is arranged distal from the top end 43 of the second cylinder 40. Hereby, the intake port 45 and the exhaust port 48 are located at different positions and separated by the top end 43 when the second piston 41 is in its TDC. In this context, the term “distal” means that the exhaust port 48 is arranged spaced apart from the top end 43 in the direction Z of the second cylinder 40 corresponding to an axial direction of the second piston 41. The top end 43 is thus considered to be a proximal part of the second cylinder 40.

More specifically, the second piston 41 is arranged in the second cylinder 40 for reciprocal movement along a central axis ZA2, here extending in the direction Z. In other words, in this example, the axial direction of the second piston 41 corresponds to the direction Z. The central axis ZA2 is thus arranged in parallel to the direction Z. Hence, the second exhaust port 48 is arranged axially distal from the top end 43 of the second cylinder 40 in the axial direction of the second cylinder 40 and the second piston 41, here corresponding to the direction Z.

By way of example, the exhaust port 48 is arranged at a lower to mid part 49 of the second cylinder 40. The exhaust port 48 is arranged at a lower to mid part 49 of the second cylinder 40 as seen along the central axis ZA2.

It should be noted that in FIG. 2, the first central axis ZA1 of the first piston 31 is arranged parallel to the second central axis ZA2 of the second piston 41. However, the pistons may also be arranged in a slightly different configuration where the first central axis ZA1 of the first piston 31 is arranged non-parallel to the second central axis ZA2 of the second piston 41, at least as long as the first and second cylinders are arranged separated from each other with a crank angle of 180 degrees.

In some examples, as illustrated in FIG. 2, when the second cylinder 40 comprises the second cylinder liner, the cylinder liner comprises the corresponding exhaust port 48 located at a lower to mid part 49 of the cylinder liner. Hence, the corresponding exhaust port 48 is generally arranged distal from the top end 43 of the second cylinder 40 and positioned in the cylinder wall 40a of the cylinder liner of the second cylinder 40.

As illustrated in FIG. 2, the pair of neighboring first and second cylinders 30, 40 are arranged separated from each other with a crank angle of 180 degrees (180 CAD). In this manner, the cylinders 20, 30 are separated from each other so to provide a 180 degrees combustion phasing separation. As such, the cylinders 30, 40 can be arranged in the ICE system 10 to provide a 180 degrees cycle separation irrespectively of the ICE and cylinder arrangement/configuration.

By arranging the exhaust ports 38, 48 in the lower to mid parts of the cylinders 30, 40, the respective intake ports 35, 45 and exhaust ports 38. 48 are in each cylinder 30, 40 located at different positions and separated by the respective piston top end 33, 43 when the respective piston is in its TDC. Accordingly, by the provision of arranging the respective intake port 35, 45 and exhaust port 38, 48 of the cylinders 30, 40 at different positions along the direction Z (i.e. along the axial directions of the pistons and cylinders), the corresponding piston will provide for a blocking effect between the intake and exhaust ports when the corresponding piston is in its TDC, so that the hot part of the cylinder (exhaust port and cylinder wall/liner) will be entirely separated from the combustible gas (air). The blocking effect is at least schematically illustrated in FIG. 2, and also in FIGS. 4A and 4D.

As such, the configuration of the intake and exhaust ports enables a length-scavenging ICE system that separates the hot exhaust end of each cylinder from the cold intake end where the combustibles are present. Therefore the knock risk may be reduced during operation of the ICE system 10. In comparison with a two-stroke diesel ICE using multiple cylinders, this also allows for a reversed scavenging of the corresponding combustion chamber with the controllable intake valves in the cylinder head and the exhaust ports at the cylinder wall/liner (e.g. in the lower part of cylinder wall). In other words, there are no exhaust valves in the cylinder head as compared to more conventional ICE systems.

By the combination of the arrangement of the ignition source 34, 44 and the position of the intake and exhaust ports 35, 45, 38, 48, the ICE system 10 is configured to provide a forced induction in the top of the cylinders, an ignition source for igniting the fuel in each combustion chamber 32, 42, while further being configured to expel the exhaust gases through respective exhaust port 28, 38 in the lower to mid parts of the respective cylinder, e.g. lower parts of the walls 30a, 40a of the cylinder liners.

Further, as depicted in FIG. 2, the ICE system 10 comprises an air intake duct 22. The air intake duct 22 is a manifold which is arranged and configured to feed intake air to the cylinders, in this example the first and second cylinders 30, 40.

The air intake duct 22 comprises a positive displacement device 23, as illustrated in FIG. 2. The positive displacement device 23 is configured to receive and feed intake air 51 to the at least one pair of neighboring cylinders 30, 40. The air intake duct 22 comprises an intake tract 24 and a plenum 25. The air intake tract 24 is arranged upstream the positive displacement device 23. The plenum 25 is arranged downstream the positive displacement device 23. The positive displacement device 23 is also arranged in the air intake duct 22 to separate the upstream intake tract 24 from the downstream plenum 25 of the air intake duct 22.

It should be noted that the plenum 25 may in some examples be an integral part of the cylinder heads of the cylinders. Hence, at least parts of the air intake duct may be integral parts of the cylinder heads of the cylinders.

The positive displacement device 23 is configured to fluidly seal against back flow from the combustion chamber(s) 32, 42. Furthermore, the positive displacement device 23 is configured to exhaust its (complete) internal displacement for each revolution.

The positive displacement device 23 is here a positive displacement pump. The positive displacement pump is configured to displace gas from an upstream position to a downstream position of the air intake duct 22 thereof by trapping a fixed amount of air and forcing that trapped amount of air from the upstream position to the downstream position.

By way of example, the positive displacement device 23 is a rotary roots type blower having a pair of rotary members 23a, 23b provided with meshing lobes. Other configurations of the positive displacement device may also be readily appreciated.

The positive displacement device 23 is here a variable positive displacement device configured to be operated in a variable manner. The use of a variable driven positive displacement device allows for a higher flexibility of the air intake duct forming the air intake system of the ICE system 10. The use of a variable driven positive displacement device also contributes to improve the overall function of the ICE system 10. Positive displacement devices may generally operate with flow and pressure as independent variables. This means that if pressure increases and speed remains constant, the flow rate is largely unaffected. A variable positive displacement device, such as a pump, is a device that converts mechanical energy to hydraulic (fluid) energy. The displacement can be varied while the pump is running. The positive displacement device may be driven variably for the high flexibility and improved functionality of the ICE system.

The positive displacement device 23 may be electrically driven, hydraulically driven, etc. An electrified positive displacement device may also improve turbo transients by boosting with scavenging that may also drive the turbine in the turbo. Such configuration of the ICE system may allow for reduced pressure before the displacement pump and/or after the turbo compressor reducing compressor work instantly.

The upstream intake tract 24 is here an integral part of the air intake duct 22. The intake duct 24 is by way of example provided in the form of a cylindrical shaped housing having an inner volume. The plenum 25 is also generally an integral part of the air intake duct 22.

Also, as illustrated in FIG. 2, the downstream plenum 25 is in fluid communication with each one of the first and second cylinders 30, 40. By way of example, as illustrated in FIG. 2, the downstream plenum 25 is in fluid communication with each one of the first and second cylinders 30, 40 via respective intake ports 35, 45.

In FIG. 2, the downstream plenum 25 is provided in the form of a so-called Siamese-shaped design. Such Siamese-shaped design has a first inlet conduit 25a and a set of two outlet conduits 25b, 25c, as schematically illustrated in FIG. 2. The diameter and length of the inlet and outlet conduits may vary depending on the type of ICE system 10, and the plenum 25 in FIG. 2 is only schematically illustrated.

The plenum 25 comprises an air inlet 25d in fluid communication with the positive displacement device 23 and a plurality of outlets 25e, 25f configured to be in fluid communication with the intake ports 35, 45 of the first and second cylinders 30, 40, respectively. The first inlet conduit 25a has the air inlet and the outlet conduits 25b, 25c have the corresponding outlets.

Accordingly, the plenum 25 is defined by the conduit arrangement between the intake ports 35, 45 of the first and second cylinders 30, 40 and the positive displacement device 23, as depicted in e.g. FIG. 2.

The plenum 25 may also be provided in other ways, e.g. by a single large inner volume defined by a common conduit. The internal volume of the plenum should generally be selected to provide an efficient backfire protection, and may thus benefit from being minimized in volume in view of the other volumes of the other components.

The plenum 25 in combination with the arrangement and configuration of the positive displacement device 23 provides for an improved air supply system for supplying air to the cylinders 30, 40.

It should be noted that even though the positive displacement device 23 provides for an essentially fluid-tight seal in the air intake duct 22, it will be a continuous flow of air through the positive displacement device 23 thanks to the configuration of the cylinders 30, 40 with a 180 CAD separation, since the pair of cylinders 30, 40 interact with respect to the intake event.

By the arrangement of the positive displacement device 23 in the air intake duct 22, the positive displacement device 25 is arranged to eliminate, or at least reduce, the risk of having pressure pulses transferred backwards from the combustion chambers 30, 40 to the upstream intake tract 24 of the air intake duct 22.

As such, the intake ports 35, 45 are mechanically isolated from the intake tract 24. The positive displacement device 23 is thus arranged to seal the cylinders 30, 40 and the downstream plenum 25 from the upstream intake tract 24 of the air intake duct 22 (intake manifold) in case of backfire.

Also, by the arrangement and configuration of the positive displacement device 23 in the air intake duct 22, the positive displacement device 23 can still provide an even flow by alternating feed to the cylinder pair 30, 40.

Moreover, the proposed ICE system provides for suppressing the tendency for knock and/or self-ignition of the fuel, such as a gaseous fuel, e.g. hydrogen-based fuel. This is e.g. provided by the combination of having a separate intake plenum 23 for each pair of cylinders 30, 40 with the 180 degrees combustion phasing separation, and where the intake duct 22 has a close coupled positive displacement device 23 for each pair of cylinders 30, 40. By arranging the positive displacement device 25 close to the cylinders, the internal volume of the plenum 25 can be minimized, thus providing for an even more efficient backfire protection.

The ICE system 20 here comprises a fuel injector arrangement 26, as illustrated in FIG. 2. The fuel injector arrangement 26 is arranged in the plenum 25 of the air intake duct 22 so as to provide a fuel injection upstream the intake ports 35, 45 of the cylinders 30, 40. In this manner, there is provided an improved injection of fuel into the combustion chambers 32, 42 of the ICE 20.

The fuel injector arrangement 26 comprises at least one fuel injector configured inject fuel. In FIG. 2, the fuel injector arrangement 26 comprises a set of two fuel injector, 26a, 26b. There is generally one fuel injector 26a, 26b arranged upstream respective intake port 35, 45. By way of example, the outlet conduit 25b comprises a first fuel injector 26a and the outlet conduit 25c comprises the second fuel injector 26b. Hereby, the ICE system 10 is configured to provide port injection of the gaseous fuel 50 upstream respective intake port 35, 45. The use of a port injection allows for providing a homogenous mixture which enables an improved knock and auto-ignition control and contribute to reduce the emissions.

The fuel injector arrangement 26 is operable/controllable in response to a fuel injection event such that fuel injection is injected to one or more of the corresponding intake ports 35, 45 such that pressure pulses are generated in the plenum 25 and subsequently travel into the corresponding combustion chambers 32, 42. Hereby, there is provided an improved scavenging effect. As such, the ICE system 10 is configured to provide a scavenging effect by the injection timing in the respective intake port 35, 45.

By way of example, the fuel injector arrangement 26 is operable/controllable to provide a sequential injection of fuel to the cylinders 30, 40 so as to allow for an active cylinder scavenging during a latter part of a corresponding intake stroke of a corresponding cylinder of the cylinders 30, 40.

Put it differently, a sequential injection enables active cylinder scavenging (emptying of exhaust) during latter part of the intake stroke and creates a final pressure pulse (from the injected fuel) that increases the trapped mass in the cylinder after any exhaust port and intake valve closures. This may also contribute to a fuel-free plenum and/or intake port after the intake valve closure.

Further, the generated pressure pulse increases the scavenging effect.

It may be noted that the sequential injection can be tuned for different speeds and valve timings.

In general, the pressure pulse will also travel backwards in the downstream plenum 25. For instance, the pressure pulse will be reflected in the sister cylinder intake valve that is closed. Thereafter, the pressure pulse travels back to the still open intake valve and enters the cylinder with the open valve and complete the cylinder filling, thus also contributing to the complete trapped mass.

In some examples, although not illustrated, the fuel injectors 26a, 26b of the fuel injector arrangement 26 may be arranged in each one of the combustion chambers of the cylinders.

Turning again to the intake ports 35, 45 and intake valves 37, 47, the ICE system 10 in FIG. 2 is here provided with a number of two intake valves 37 for the first cylinder 30 and a number of two intake control valve 47 for the second cylinder 40.

Hence, in some examples, each one of the cylinder heads 30b, 40b comprises a number of at least two intake control valves. In some examples, each one of the cylinder heads 30b, 40b of the first and second cylinders 30, 40 may have a plurality of intake control valves. By way of example, each one of the cylinder heads may have a number of four intake control valves. Such configuration provides for an even more improved air supply system for supplying air to each one of the cylinders. A configuration with an ICE system having four intake control valves for each cylinder is particularly beneficial for two-stroke operated ICE systems operable on a hydrogen-based fuel because it has a shorter intake period than a four stroke ICE system. Also, a configuration with an ICE system having four intake control valves for each cylinder allows for increasing the air intake rate into the combustion chambers 32, 42 of the cylinders 30, 40, thus also improving the volumetric efficiency. To this end, an ICE system 10 comprising the arrangement of the positive displacement device 23 in combination with the arrangement of four intake valves in each cylinder enables an even more improved volumetric efficiency, at least in comparison with conventional ICE system, such as a four-stroke ICE system.

In FIG. 2, the intake control valves 37, 47 are configured to provide variable valve actuation. The variable valve actuation can be provided by a hydraulic system, electronic system or pneumatic system. However, the intake control valves 37, 47 may also be conventional intake control valves, such as a camshaft-based system, as is commonly used in diesel ICE systems. Hence, in some examples, the intake control valves are conventional camshaft actuated valves. Such camshaft actuated valves may also include variable valve actuation depending on arrangement and configuration of the valves.

In FIG. 2, the ICE system 10 comprises an inlet control valve actuation assembly 63 for actuating the at least one inlet control valve 37 and the corresponding inlet control valve 47. The inlet valve actuation assembly 63 is adapted to actuate the inlet control valves 37, 47 in accordance with one or more lift modes during the combustion cycle of the ICE system, which will also be further described in relation to FIGS. 4A to 4D.

As may also be gleaned from FIG. 2, each one of the exhaust ports 38, 48 is arranged in fluid communication with an exhaust duct 61 arranged to transport exhaust gas away from each one of the cylinders.

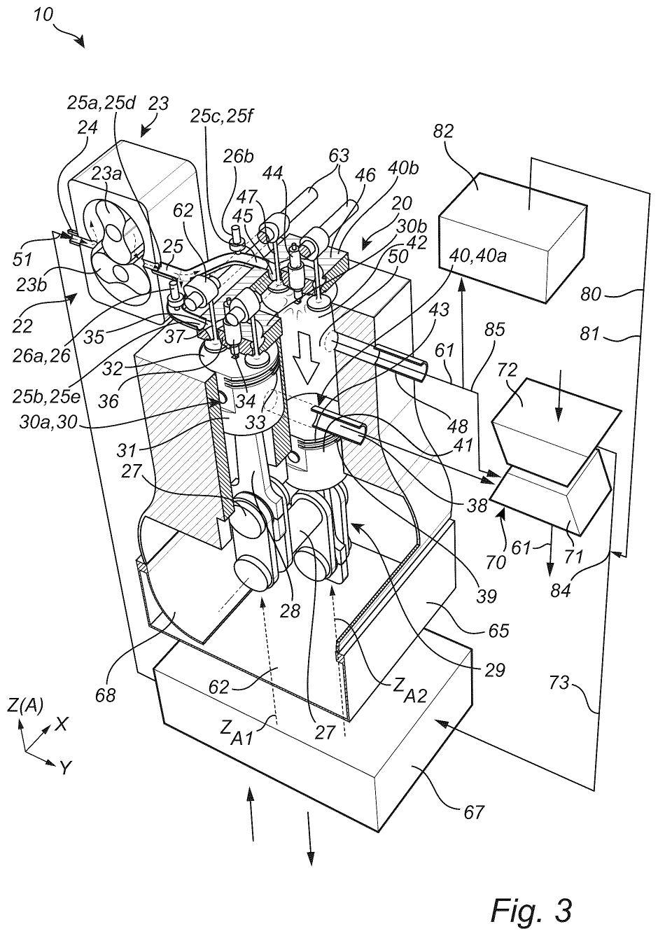

FIG. 3 is another example of the ICE system 10. The ICE system 10 here comprises the features and components of the ICE system 10 as described in relation to FIG. 2 and FIGS. 4A to 4D. The ICE system 10 illustrated in FIG. 3 differs from that shown in FIG. 2 in that the ICE system 10 also comprises a turbocharger arrangement 70. The turbocharger arrangement 70 comprises a turbocharger turbine 71 operatively connected to a turbocharger compressor 72, wherein the turbocharger compressor 72 is arranged in an air intake conduit 73 in fluid communication with the air intake duct 22. The turbocharger turbine 71 is arranged in the exhaust duct 61 so as to drive the turbocharger compressor 72. In other words, the turbine 71 is configured to convert engine exhaust gas into mechanical energy to drive the compressor 72.

The turbocharger turbine 71 may be a conventional turbine for an ICE system 10. Alternatively, the turbocharger turbine 71 may be a variable geometry turbine in fluid communication with the cylinders.

In FIG. 3, the ICE system 10 further comprises an exhaust gas recirculation, EGR, system 80 comprising an EGR conduit 81 arranged to connect the exhaust duct 61 and the air intake duct 22 so as to permit recirculation of exhaust gas through the cylinders during operation of the ICE 20.

The EGR system 80 here further comprises a corresponding positive displacement device 82. The positive displacement device 82 is disposed in the EGR conduit 81. The positive displacement device 82 is generally of the same type as the device 23, but may also be provided in other ways. The positive displacement device 82 is by way of example a roots blower.

The EGR conduit 81 connects to the air intake conduit 73 at a position 84 downstream the turbocharger compressor 72 and further connects to the exhaust duct 61 at a position 85 upstream the turbocharger turbine 71.

Typically, as illustrated in FIG. 3, the ICE system 10 may also comprise an air cooler 67, such as charge air cooler (CAC). By way of example, the CAC 67 is arranged in the air intake conduit 73. More specifically, the CAC 67 is arranged in the air intake conduit 73 between the turbocharger compressor 72 and the air intake duct 72, as seen in a direction of flow from the compressor 72 to the air intake duct 22.

It should be readily appreciated that the air intake duct of FIG. 2 and/or FIG. 3 may have its own inlet for receiving fresh air from the outside and/or be configured to receive air from the air intake conduit 73.

For ICE systems 10 with a turbocharged arrangement 70 as illustrated in FIG. 3, the positive displacement device 23 can work in several ways working in conjunction with the turbo mounted upstream:

If the intake air flow is at the desired level the positive displacement device 23 just spins to move the air volume past the rotors. In this instance, the positive displacement device consumes little energy since no compression is taking place. The part of blocking of the intake duct 22 from the upstream intake tract 24 is then also functioning (per design).

If in a transient state and the turbocharger have not spun up, the positive displacement device 23 can spin faster and support in getting the boost pressure up, thereby increasing the response of the ICE 20. Transient operation is generally challenging for H2 ICE system 10 with a traditional boosting setup since a transient normally result in reduced air/fuel ratio which in turn give a knock tendency or NOx creation. By controlling the air during the transient with additional boost, this issue may be eliminated, or at least reduced to a great extent.

At some operating points, where the turbo is not sufficient for the boosting the positive displacement device 23 can support with additional boosting for improved control of air/fuel ratio, cylinder scavenging etc., i.e. combustion control.

Moreover, in the ICE system 10 described in relation to FIG. 2 and/or FIG. 3, the ICE system 10 further comprises the controller 90 configured to collectively control the positive displacement device 23 and the intake valves 37, 47 so as to control flow of gas to the respective combustion chambers 32, 42.

By way of example, the controller 90 is configured to terminate fuel injection during an intake phase and before an intake valve closure, whereby the remaining part of the intake phase comprises emptying the plenum 25 of fuel and subsequently introducing fresh air to the plenum 25 by operating the positive displacement device 23.

In the following, there is an example of a sequence of operating the ICE system 10 during the two-stroke operation. The sequence of the two-stroke operation is described in conjunction with FIGS. 4A to 4D.

In generally, it should be noted that each one of the first and second cylinders 30, 40 has three primary events. These events are compression event, combustion and work event, and exhaust and intake event. The compression event occurs when a corresponding piston is at an upper half of the corresponding cylinder when it travels from BDC to TDC. The combustion and work event occurs when a corresponding piston is at an upper half of the corresponding cylinder when it travels from TDC to BDC. The exhaust and intake event generally occurs when a corresponding piston is at a lower half of the corresponding cylinder. By way of examples, the exhaust and intake event occurs when a corresponding piston is at a lower half of the cylinder and is travelling towards its BDC, across its BDC and/or when the corresponding piston is at a lower half of the cylinder and is travelling towards its TDC.

It should, however, be noted that the exhaust and intake event may occur in different regions of the cylinders, and can be slightly divided, but the exhaust and intake event will generally occur at the same time. During the exhaust and intake event, the ICE system provides the scavenging effect, i.e. fresh intake gas pushes the residual exhaust out the exhaust port.

In view of the above, the piston 31, 41 of one of the cylinders 30, 40 may generally perform the compression phase (or event) during about 270-0 CAD, followed by the combustion and work phase (event) during 0-90 CAD at an upper half of the corresponding cylinder when the piston travels from TDC to BDC, while the other piston of the other cylinder performs the exhaust and intake phase (event) at a lower half of the other cylinder during 90 to 270 CAD. It may also be noted that there is generally an overlap between the end of the combustion and work phase (event) and the start of the exhaust and intake phase (event).

More specifically, as schematically illustrated in FIGS. 4A to 4D, the intake control valve 37 of the first cylinder 30 is operable in correlation with the movement of the first piston 31 and the intake control valve 47 of the second cylinder 40 is operable in correlation with the movement of the second piston 41. In this manner, the fluid communication between the respective combustion chambers 32, 42 and the plenum 25 is selectively open and closed during a crank shaft revolution of the ICE 20. As mentioned herein, such configuration of the ICE system 10 in combination with the positive displacement device 23 in the air intake duct 22 allows for reducing risk of backfire.

The inlet control valve 37 and the corresponding inlet control valve 47 are controlled and actuated by the inlet control valve actuation assembly 63. Purely by way of example, the inlet control valve actuation assembly 63 may comprise an electric actuator (not shown) adapted to actuate the inlet control valve(s) in at least two lift modes, i.e. between an open mode and a closed mode.

In addition, as mentioned above, the cylinders 30, 40 are separated from each other with a crank angle of 180 degrees. Such arrangement and configuration of the ICE system 20 allows for 180 degrees combustion phasing separation. The effect of the control of the intake ports by the intake valves in combination with the 180 degrees combustion phasing separation can be exemplified by the illustrations in FIGS. 4A and 4D:

In FIG. 4A, the first intake port 35 of the first cylinder 30 is closed by the inlet control valve 37 to close the fluid communication between the first combustion chamber 32 and the plenum 25 when the corresponding intake port 45 of the second cylinder 40 is open by the inlet control valve 47 to provide a fluid communication between the second combustion chamber 42 and the plenum 25. In FIG. 4A, the first piston 31 is positioned in its TDC. In this position, an ignition event of the first cylinder 30 is about to start, or has just been started. The inlet control valve 37 is thus closed. In addition, in FIG. 4A, the second piston 41 is at its BDC and the corresponding inlet control valve 47 of the second cylinder 40 is fully opened. The second cylinder 40 and the second piston 41 are here illustrated in a position corresponding to the exhaust and intake event, i.e. fresh intake gas from the intake port 45 enters the second cylinder 40 and pushes the residual exhaust out from the exhaust port 48. This simultaneous operation of the first and second pistons 31, 41 can be performed due to the 180 crank angel degrees separation between the cylinders 30, 40, here also providing the 180 degrees combustion phasing separation.

Subsequently, as illustrated in FIG. 4B, the first cylinder 30 and the first piston 31 perform the combustion and work phase, in which the first piston 31 travels from its TDC to its BDC. In this position, the inlet control valve 37 is closed. In addition, as illustrated in FIG. 4B, the second piston 41 in the second cylinder 40 travels from its BDC to its TDC, while performing its intake phase so as to receive fresh air from the corresponding intake port 45. In this position, the corresponding inlet control valve 47 is partly opened, as illustrated in FIG. 4B. This simultaneous operation of the first and second pistons 31, 41 can be performed due to the 180 crank angel degrees separation between the cylinders 30, 40, here also providing the 180 degrees combustion phasing separation.

In FIG. 4C, the first cylinder 30 and the first piston 31 are illustrated at the end of the combustion and work phase, in which the first piston 31 approaches its BDC. In this position, the inlet control valve 37 is controlled to move from its closed position to an opened position. Hence, in FIG. 4C, the inlet control valve 37 is illustrated in a partly opened position. In addition, as illustrated in FIG. 4C, the second piston 41 approaches its TDC while the corresponding inlet control valve 47 is set to its closed position. At this position, the second cylinder 40 and the second piston 41 perform the compression phase so as to compress the received fresh air. This simultaneous operation of the first and second pistons 31, 41 can be performed due to the 180 crank angel degrees separation between the cylinders 30, 40, here also providing the 180 degrees combustion phasing separation.

Finally, as illustrated in FIG. 4D, the first piston 31 is at its BDC and the corresponding inlet control valve 37 of the first cylinder 30 is fully opened. The first cylinder 30 and the first piston 31 are here in a position corresponding to the exhaust and intake event, i.e. fresh intake gas from the intake port 35 enters the first cylinder 30 and pushes the residual exhaust out from the exhaust port 38. In addition, the second piston 41 is positioned in its TDC. In this position, an ignition event of the second cylinder 40 is about to start, or has just been started. The corresponding inlet control valve 47 is thus closed. This simultaneous operation of the first and second pistons 31, 41 can be performed due to the 180 crank angel degrees separation between the cylinders 30, 40, here also providing the 180 degrees combustion phasing separation.

As may also be gleaned from FIG. 4D, the inlet control valve 37 at the first intake port 35 of the first cylinder 30 is open to provide a fluid communication between the first combustion chamber 32 and the plenum 25 when the corresponding intake port 45 of the second cylinder 40 is closed by the intake control valve 47 to close the fluid communication between the second combustion chamber 42 and the plenum 25.

In addition, as may be gleaned from FIGS. 4A to 4D, due to the arrangement of the first and second cylinders 30, 40 being arranged separated from each other with a crank angle of 180 degrees, the ICE system 10 is configured to operate the intake valves 37, 47 of the first and second cylinders 30, 40 such that the intake valves 37, 47 of the cylinders 30, 40 are completely closed when the respective piston is halfway up in the cylinder, which may further reduce the risk of a backfire.

Accordingly, by the configuration of having the first and second cylinders 30, 40 separated from each other by 180 crank angle degrees in combination with the arrangement of the positive displacement device 23, as illustrated in e.g. FIG. 2 in combination with FIGS. 4A to 4D, it becomes possible to reduce the risk of backfire.

Also, although not explicitly shown in FIGS. 4A to 4D, it should be readily appreciated that at injection, after scavenging has started, the injected hydrogen fuel will expand and create a pulse in the intake ports and plenum. This pulse will propagate and add to the scavenging effect and also increase the pressure in the cylinder. However, the pulse is limited from travelling backwards in the air intake duct (air intake system) by the positive displacement device 23 acting like a check valve and also momentarily adding boost pressure during the pulse.

Moreover, depending on when in time the intake valves 37, 47 are closed, the ICE system 10 is operable to expand the combustible gas during a longer time period in the combustion chambers 30, 40 in comparison to the duration of the compression phase. In this manner, there is provided a built-in Miller or Atkinson cycle function that increases efficiency.

Further, since the two-stroke cycle of the ICE system 10 provides for twice as many work cycles as a conventional four-stroke ICE per revolution, the ICE system 10 allows for operating in a lean condition where it is not possible to get as much power per work cycle as a conventional diesel ICE. I.e. while hydrogen gas and other gases need to be run lean for emission purposes (NOx control), the two-stroke cycle allows for creating twice as many work cycles at the same ICE rpm.

In operation of the ICE system 10, the ICE system 10 may perform the following method:

In a step S10, when a piston is travelling down from TDC to BDC in one of the cylinders during expansion of the combustibles and a corresponding exhaust port is uncovered, the effective work stroke is ended, and the gases are exhausted through the exhaust port. Subsequently, in a step S20, the intake valve(s) of one of the cylinder opens and the cylinder is purged by incoming air fed by the aforementioned boosting system (e.g. by the turbocharger arrangement 70 and the positive displacement device 23). At this stage there is no fuel present in the boost mass or the cylinder.

Then, in step S30, the piston reaches BDC. Thereafter, in step S40, the piston starts to move up towards its TDC and the piston eventually covers the exhaust port again. At this position, the fuel injector arrangement is operated to inject e.g. hydrogen fuel. The hydrogen fuel is injected into the intake port, creating the pressure pulse from the injected hydrogen fuel. As such, the ICE system 10 is operated to start injecting hydrogen gas into the air stream in the plenum 25, thus feeding air and hydrogen into the cylinder. The injection starts after the intake valve has opened just after the initial scavenging (cylinder purge) and ends before the intake valve closes which provides an essentially intake tract free of combustible gas.

Initial scavenging of the cylinder (purging) is the time between IVO and start of hydrogen gas injection.

In step S50, the piston continues to travel up (about halfway) through the stroke and the intake valves closes.

In step 560, the piston travels to just before TDC, TDC or just after TDC (i.e. close to TDC).

Subsequently, in step S70, the ignition source (e.g. a spark plug) ignites the homogenous air/hydrogen mix in the cylinder(s).

Then, in step S80, the piston is forced down in the work stroke (expansion).

Thereafter, in step S90, the cycle repeats from above steps S10 to S80.

As should be readily appreciated from the above, the operation of purging, scavenging and subsequent fuel injection operation, creating a boost pulse, as well as the ending of fuel injection where hydrogen (H2)/air mixture is pushed into the cylinder allows for emptying the plenum 25, while the positive displacement device 23 is operated to push in fresh air in the plenum 25. In this manner, the arrangement and configuration of the ICE system 10 provides for avoiding, or at least reducing the risk of having hydrogen mixture in the plenum 25, hence, reducing the risk for backfire.

It should be noted that if the intake valves are opened all at the same time, a flow effect in the whole cross section area of the cylinder can be obtained so that the cylinder is filled homogenously from top to bottom, driving out the exhaust gases so that low mixing between the fresh charge air and the warm exhaust combustibles is obtained. This may be useful so as to reduce the mixture temperature and residuals in preparation of the mixture. The intake valves are then completely closed when the piston is halfway up in the cylinder which reduces the risk of a backfire.

It should be noted that the above presentation of the ICE system 10 should also be regarded as disclosing a method for controlling the ICE system 10, for instance using the controller 90.

The combustion chambers can be designed in several different manners and may be any one of a flat, hemispherical, or pent roof design with only intake valves. It may be beneficial to cover a large area of the combustion chamber with valves so that the cylinder filling can be made in an efficient manner.

All moving parts in the ICE 20 may generally be lubricated by means of conventional pressure lubrication. Other options are also possible.

The positive displacement device 23 and the plenum 25 of the air intake duct 22 are generally considered to be the cold components and may be made from an aluminum alloy. The air intake duct 22 may typically be fastened to the cylinder heads that may be warmer, which is made of cast iron or steel. This may minimize the risk of hydrogen embrittlement since no gas containing hydrogen comes into contact with any iron or steel that is colder than 150 degrees C., which is the threshold when hydrogen embrittlement is considered to occur.

The ICE system 10 can be cooled in several different ways. By way of example, the ICE system 10 comprises a controlled low temperature coolant circuit for temperature control of the CAC (Compressed Air Cooler) and/or the EGR cooler. By this, the condensation level of the returned water from the combustibles (H2 produce H2O when combusted) is controlled. In addition, the ICE system 10 may comprise water injection system. The water injection system can be arranged and configured to inject water in the intake port(s), directly into the cylinder, or prior to the intake positive displacement device 23. Moreover, the condensed water from the exhaust can be used for water injection. If it is injected prior to the positive displacement device, there is a benefit of mixing and evaporation/cooling in the roots blower. The water injection as a temperature reduction medium for the boost air after the positive displacement device is an advantage in examples where the positive displacement device is used for compression work for additional boosting.

It should be noted that the ICE system 10 may not be restricted to a system with one single pair of cylinders 30, 40, but can also be implemented in an ICE system comprising four cylinders, six cylinders etc. Hence, the ICE system 10 may have a minimum of two cylinders, but multiples of two cylinders may likewise be possible.

In ICE systems 10 further comprising additional pairs of neighboring cylinders, each arrangement of a pair of neighboring cylinders has a corresponding air intake duct with a corresponding positive displacement device.

In other words, a four-cylinders ICE will have two positive displacement devices and a six-cylinder ICE will have three positive displacement devices. Such ICE system may also use a positive displacement device with a plurality of separated sections, wherein each section is provided to cooperated with a given pair of cylinders. In this arrangement, the flow of fluid (air) to each pair of cylinders should be separated from each other. The cylinder pairs can be arranged spaced-apart so as to allow for ignition of fuel for three cylinders at once (flat crank) or arranged evenly offset from each other for an evenly spread firing order. In this way, it becomes possible to charge one cylinder in the pair at the time without creating unwanted pulsation since one cylinder is in its intake stroke while the other one is in its work stroke.

Moreover, the present disclosure may be exemplified by any one of the below examples.

Example 1: A spark-ignition internal combustion engine, ICE, system 10 for a vehicle, comprising: a two-stroke ICE 20 operable on a gaseous fuel or a liquid fuel 50, the ICE having at least a pair of first and second cylinders 30, 40 with corresponding first and second cylinder walls 30a, 40a, the first cylinder accommodating a reciprocating first piston 31 operable between a bottom dead center and a top dead center, and further at least partly defining a first combustion chamber 32 with a top end 33 of the first piston, wherein the first cylinder further comprises an ignition source 34 arranged in the first combustion chamber, at least one intake port 35 arranged at a top end 36 of the first cylinder and in fluid communication with the combustion chamber, wherein the flow of combustible gas through the at least one intake port is controllable by an intake control valve 37, and further an exhaust port 38 arranged distal from the top end of the first cylinder, such that the at least one intake port and the exhaust port are located at different positions and separated by the piston top end when the first piston is in its top dead center, the second cylinder accommodating a reciprocating second piston 41 operable between a bottom dead center and a top dead center, and further at least partly defining a second combustion chamber 42 with a top end 43 of the second piston, wherein the second cylinder further comprises a corresponding ignition source 44 arranged in the second combustion chamber, at least one corresponding intake port 45 arranged at a top end 46 of the second cylinder and in fluid communication with the second combustion chamber, wherein the flow of combustible gas through the at least one corresponding intake port is controllable by a corresponding intake control valve 47, and further a corresponding exhaust port 48 arranged distal from the top end of the second cylinder, such that the at least one corresponding intake port and the corresponding exhaust port are located at different positions and separated by the piston top end when the second piston is in its top dead center, the pair of first and second cylinders being arranged separated from each other with a crank angle of 180 degrees, and an air intake duct 22 comprising a positive displacement device 23 configured to receive and feed intake air to the at least one pair of cylinders, the positive displacement device further being arranged in the air intake duct to separate an upstream intake tract 24 from a downstream plenum 25 of the air intake duct, the downstream plenum being in fluid communication with each one of the first and second cylinders of the at least one pair of cylinders.

Example 2: The ICE system of example 1, wherein the ICE system comprises a fuel injector arrangement 26 arranged in the downstream plenum of the air intake duct so as to provide a fuel injection upstream the intake ports of the first and second cylinders.

Example 3: The ICE system of example 2, wherein the fuel injector arrangement is controllable in response to a fuel injection event such that fuel injection is injected to the intake port and the corresponding intake port such that pressure pulses are generated in the plenum and subsequently travel into the corresponding combustion chambers.

Example 4: The ICE system according to any one of examples 2 and 3, wherein the fuel injector arrangement is controllable to provide a sequential injection of fuel to the first and second cylinders so as to allow for active cylinder scavenging during a latter part of a corresponding intake stroke of a corresponding cylinder of the first and second cylinders.

Example 5: The ICE system according to any one of the preceding examples, wherein the intake control valve of the first cylinder is controllable in correlation with the movement of the first piston and the intake control valve of the second cylinder is controllable in correlation with the movement of the second piston such that fluid communication between the respective combustion chambers and the downstream plenum being selectively open and closed during a crank shaft revolution of the ICE.

Example 6: The ICE system according to any one of the preceding examples, wherein the plenum comprises an air inlet in fluid communication with the positive displacement device and a plurality of outlets configured to be in fluid communication with the intake ports of the first and second cylinders.

Example 7: The ICE system according to any one of the preceding examples, wherein the intake control valves are configured to provide variable valve actuation.

Example 8: The ICE system according to any one of the preceding examples, wherein the positive displacement device is a variable positive displacement device configured to be operated in a variable manner.

Example 9: The ICE system according to any one of the preceding examples, wherein the exhaust ports are arranged in fluid communication with an exhaust duct 61 arranged to transport exhaust gas away from the cylinders.

Example 10: The ICE system according to any one of the preceding examples, further comprising a turbocharger arrangement 70 having a turbocharger turbine 71 operatively connected to a turbocharger compressor 72, wherein the turbocharger compressor is arranged in an air intake conduit 73 to the air intake duct, wherein the turbocharger turbine is arranged in the exhaust duct so as to drive the turbocharger compressor.

Example 11: The ICE system according to any one of the preceding examples, further comprising an exhaust gas recirculation EGR system 80 comprising an EGR conduit 81 arranged to connect the exhaust duct 61 and the air intake duct 22 so as to permit recirculation of exhaust gas through the cylinders during operation of the ICE.

Example 12: The ICE system according to example 11, wherein the EGR system further comprises a corresponding positive displacement device 82.

Example 13: The ICE system according to example 12 or example 13, wherein the EGR conduit connects to the air intake conduit at a position 84 downstream the turbocharger compressor and further connects to the exhaust duct at a position 85 upstream the turbocharger turbine.

Example 14: The ICE system according to any one of the preceding examples, wherein the ICE system is a hydrogen ICE system configured to operate on a gaseous fuel containing a hydrogen-based gaseous fuel.

Example 15: The ICE system according to any one of the preceding examples, wherein the ICE system is configured to collectively control the positive displacement device and the intake valves so as to control flow of gas to the combustion chambers.

Example 16: The ICE system according to example 15, wherein the ICE system is configured to be controllable to terminate fuel injection during an intake phase and before an intake valve closure, whereby the remaining part of the intake phase comprises emptying the plenum of fuel and subsequently introducing fresh air to the plenum by operating the positive displacement device.

Example 17: The ICE system according to any one of the preceding examples, wherein the ICE system comprises a multiple set of pair of cylinders having corresponding air intake ducts with corresponding positive displacement devices.

Example 18: A vehicle comprising an internal combustion engine system according to any one of the examples 1 to 17.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows.

Also, the term “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A spark-ignition internal combustion engine (ICE) system for a vehicle, the spark-ignition ICE system comprising:
a two-stroke ICE operable on a gaseous fuel or a liquid fuel, the two-stroke ICE having at least a pair of first and second cylinders with corresponding first and second cylinder walls,
the first cylinder accommodating a reciprocating first piston operable between a bottom dead center and a top dead center, and further at least partly defining a first combustion chamber with a top end of the first piston, wherein the first cylinder further comprises an ignition source arranged in the first combustion chamber, at least one intake port arranged at a top end of the first cylinder and in fluid communication with the first combustion chamber, wherein a flow of combustible gas through the at least one intake port is controllable by an intake control valve, and further an exhaust port arranged distal from the top end of the first cylinder, such that the at least one intake port and the exhaust port are located at different positions and separated by the first piston top end when the first piston is in its top dead center,
the second cylinder accommodating a reciprocating second piston operable between a bottom dead center and a top dead center, and further at least partly defining a second combustion chamber with a top end of the second piston, wherein the second cylinder further comprises a corresponding ignition source arranged in the second combustion chamber, at least one corresponding intake port arranged at a top end of the second cylinder and in fluid communication with the second combustion chamber, wherein the flow of combustible gas through the at least one corresponding intake port is controllable by a corresponding intake control valve, and further a corresponding exhaust port arranged distal from the top end of the second cylinder, such that the at least one corresponding intake port and the corresponding exhaust port are located at different positions and separated by the second piston top end when the second piston is in its top dead center,
the pair of first and second cylinders being arranged separated from each other with a crank angle of 180 degrees, and
an air intake duct comprising a positive displacement device configured to receive and feed intake air to the at least one pair of first and second cylinders, the positive displacement device further being arranged in the air intake duct to separate an upstream intake tract from a downstream plenum of the air intake duct, the downstream plenum being in fluid communication with each one of the first and second cylinders of the at least one pair of first and second cylinders.

2. The ICE system according to claim 1, wherein the ICE system comprises a fuel injector arrangement arranged in the downstream plenum of the air intake duct so as to provide a fuel injection upstream the intake ports of the first and second cylinders.

3. The ICE system according to claim 2, wherein the fuel injector arrangement is controllable to provide a sequential injection of fuel to the first and second cylinders so as to allow for an active cylinder scavenging during a latter part of a corresponding intake stroke of a corresponding cylinder of the first and second cylinders.

4. The ICE system according to claim 1, wherein the intake control valve of the first cylinder is controllable in correlation with movement of the first piston and the corresponding intake control valve of the second cylinder is controllable in correlation with the movement of the second piston such that fluid communication between the respective first and second combustion chambers and the downstream plenum being selectively open and closed during a crank shaft revolution of the ICE.

5. The ICE system according to claim 1, wherein the plenum comprises an air inlet in fluid communication with the positive displacement device and a plurality of outlets configured to be in fluid communication with the intake ports of the first and second cylinders.

6. The ICE system according to claim 1, wherein the positive displacement device is a variable positive displacement device configured to be operated in a variable manner.

7. The ICE system according to claim 1, further comprising a turbocharger arrangement having a turbocharger turbine operatively connected to a turbocharger compressor, wherein the turbocharger compressor is arranged in an air intake conduit to the air intake duct, and wherein the turbocharger turbine is arranged in an exhaust duct so as to drive the turbocharger compressor.

8. The ICE system according to claim 7, further comprising an exhaust gas recirculation (EGR) system comprising an EGR conduit arranged to connect exhaust duct and air intake duct so as to permit recirculation of exhaust gas through the cylinder(s) during operation of the ICE.

9. The ICE system according to claim 8, wherein the EGR system further comprises a corresponding positive displacement device.

10. The ICE system according to claim 8, wherein the EGR conduit connects to the air intake conduit at a position downstream the turbocharger compressor and further connects to the exhaust duct at a position upstream the turbocharger turbine.

11. The ICE system according to claim 1, wherein the ICE system is a hydrogen ICE system configured to operate on a gaseous fuel containing a hydrogen-based gaseous fuel.

12. The ICE system according to claim 1, wherein the ICE system is configured to collectively control the positive displacement device and the intake valves so as to control flow of gas to the first and second combustion chambers.

13. The ICE system according to claim 1, wherein the ICE system is configured to be controllable to terminate fuel injection during an intake phase and before an intake valve closure, whereby the remaining part of the intake phase comprises emptying the plenum of fuel and subsequently introducing fresh air to the plenum by operating the positive displacement device.

14. The ICE system according to claim 1, wherein the ICE system comprises a multiple set of pair of cylinders having corresponding air intake ducts with corresponding positive displacement devices.

15. A vehicle comprising an internal combustion engine system according to claim 1.
